(19) United States
(12) Patent Application Publication
(10) Pub. No.: US 2026/0131373 A1
(43) Pub. Date: May 14, 2026

(54) PART PRESENTER FOR A BLIND FASTENER SETTING TOOL

(71) Applicant: NEWFREY LLC, New Britain, CT (US)

(72) Inventors: Tim BERNDT, Giessen (DE); Manuel SCHNEIDER, Giessen (DE); Christof CLEMEN, Giessen (DE); Paul GIANFERRARA, Troy, MI (US)

(73) Assignee: NEWFREY LLC, New Britain, CT (US)

(21) Appl. No.: 18/941,759

(22) Filed: Nov. 8, 2024

(51) Int. Cl. B21J 15/32

(52) U.S. Cl. CPC B21J 15/32

(57) ABSTRACT

A blind fastener presenter assembly for presenting blind fasteners to a screw tool of a blind fastener setting tool. The part presenter comprises receiver, a gripper, and a handover unit. The receiver is configured to successively deliver the blind fasteners from a storage location to the gripper. The gripper is configured to receive, orient, and secure the blind fastener in place after it is received from the receiver. The handover unit is configured to move the gripper from a nested position where the gripper receives the blind fastener from the receiver to an extended position where the gripper delivers the blind fastener to the threaded screw tool for setting in the workpiece.

### BACKGROUND

The invention is generally directed to a setting tool for setting a blind fastener or blind element in a workpiece, and more particularly directed to a blind fastener presenting assembly for presenting blind fasteners to a screw tool of a blind fastener setting tool.

In certain types of manufacturing, such as motor vehicle manufacturing, it is common that various components such as strips, rails, and other elements are fastened to thin-walled components, such as sheet metal or profiles of aluminum. A common method of connecting these types of components is to use a fastener having a screw thread.

Blind fasteners are fastening elements that are to be arranged in an opening, for example, in an opening of a metal sheet or any other sheet or workpiece. They are commonly used to secure a plurality of work pieces together when it is difficult or impossible to access the blind side of one of the work pieces. Blind fasteners have generally incorporated a sleeve or shank that expands and bends during installation. A blind fastener can be a blind rivet, a blind rivet nut, a self-drilling self-tapping screw, or similar fasteners. A blind fastener can provide an internal thread and thus render possible a screw connection to metal sheets or workpieces, the wall thickness of which is not sufficient to embody a thread.

A blind fastener setting device or setting tool for blind fasteners is used to set the blind fastener in the opening of the workpiece. An exemplary blind fastener setting tool is described in U.S. Pat. No. 11,738,384 (Gianferrara et al.) issued Aug. 29, 2023, which is hereby incorporated by this reference. The blind fastener has, in a non-deformed state, a hollow cylindrical rivet shank with a radially extending set head embodied on one end and an internal thread formed (for instance for a blind rivet nut) and/or a mandrel may be arranged (for example for a blind rivet) on another end. It is known to use a bolt having an external thread cooperating with the internal thread of the blind rivet nut to set the blind rivet nut in the hole/opening. The internal thread of the blind rivet nut engages with the external thread of the bolt.

The blind fastener is inserted with the rivet shank first into the hole until the rivet head contacts the sheet. By start-up of the blind fastener setting device, the bolt or the mandrel and thus the thread region is then moved axially backwards from the blind fastener and the sheet, whereby a compression of the rivet shank occurs. A bead or a bulge is formed at a desired deformation point at the workpiece side facing away from the rivet head. The blind fastener is thus held captively in the hole. To remove the setting device from the set blind fastener, pressure on the bolt is relieved and it is rotated in the drill-off direction. The blind fastener setting device is then available for a new setting operation.

Some setting devices may use a part presenter to deliver the blind fastener to the threaded screw tool of the setting device. The part presenter moves from a first position where it receives the fastener to a second position where it delivers the fastener to the screw tool. One problem with these types of existing setting devices is that the part presenters travel along a path which requires them to move a significant distance away from the housing of the setting device when moving between the first position and the second position. This requires there to be significant clearance around the setting device during operation which can be problematic, especially in small manufacturing areas. Additionally, in some devices the setting device has a long stroke moving linearly backwards a significant distance in order to allow the part presenter to move into position. In effect, the setting device must be very large and have significant clearance around it for the part presenter to properly deliver the blind fastener to the threaded screw tool. Further, some existing setting devices having part presenters requiring the threaded screw tool or tool nose of the setting device to travel a significant distance away from the workpiece in order to interface with the part presenter. This takes time and reduces the efficiency of the manufacturing operation. Still further, the travel path of the part presenter must be precise in order for it to deliver the blind fastener to the threaded screw tool. Some existing part presenters use rotary motion to deliver the blind fastener to the threaded screw tool. Calibrating these types of rotating part presenters to precisely deliver the blind fastener can be difficult to achieve and maintain.

There is therefore a need for an improved part presenter which overcomes these and other shortcomings.

### SUMMARY

One aspect of the present disclosure relates to a blind fastener setting tool device for attaching one or more blind fasteners to a workpiece. The blind fastener setting tool has a housing and a threaded screw tool that is rotationally and translationally movable within the housing along and around a tool axis between a retracted position and an extended position. The setting tool device also has at least one motor and a roller screw arranged for rotation and axial movement in the housing and that is operably engaged to the at least one motor. The roller screw is operably engaged to the threaded screw tool. The blind fastener setting tool includes a part presenter having receiver, a gripper, and a handover unit. The receiver is configured to successively deliver blind fasteners from a storage location to the gripper. The receiver comprises an input end, an output end, and a channel or feeder tube disposed between the input end and the output end. A fastener supply tube delivers blind fasteners from the storage location to the receiver and is in communication with the input end of the channel. The gripper is configured to receive, orient, and secure the blind fastener in place after it is received from the receiver. The gripper comprises a housing with an aperture, a receptacle configured to receive a blind fastener and a clamping device disposed within the housing. The clamping device has one or more clamping jaws disposed around the aperture. The clamping jaws have an open position and a closed position and may or may not be symmetrical. In some embodiments, in the closed position the inner periphery of the jaws generally corresponds to the outer perimeter of a blind fastener. The part presenter also includes a handover unit configured to move the gripper from a first (retracted) position where the gripper receives the blind fastener from the receiver to a second (extended) position where the gripper delivers the blind fastener to the threaded screw tool for setting in the workpiece. The handover unit comprises a conveyance system for moving the gripper along a predefined pathway. The conveyance system includes a first support member spaced apart from a second support member. The support members have at least one track for guiding the movement of handover unit and correspondingly the gripper. In some embodiments this is done with guide bearings which limit the conveyance system's movement to a predefined pathway provided by the tracks. A piston actuator is operably engaged to the conveyance system and drives the extension and retraction of the conveyance system.

Another aspect of the present disclosure relates to a blind fastener presenter assembly for presenting blind fasteners to a screw tool of a blind fastener setting tool. The part presenter comprises receiver, a gripper, and a handover unit. The receiver is configured to successively deliver blind fasteners from a storage location to the gripper. The receiver comprises an input end, an output end, and a channel or feeder tube disposed between the input end and the output end. A fastener supply tube delivers blind fasteners from the storage location to the receiver is in communication with the input end of the channel. The gripper is configured to receive, orient, and secure the blind fastener in place after it is received from the receiver. The gripper comprises a housing with an aperture, a receptacle configured to receive a blind fastener and a clamping device disposed within the housing. The clamping device has one or more clamping jaws disposed around the aperture. The clamping jaws have an open position and a closed position and may or may not be symmetrical. In some embodiments, in the closed position the inner periphery of the jaws generally corresponds to the outer perimeter of a blind fastener. The part presenter also includes a handover unit configured to move the gripper from a first (retracted) position where the gripper receives the blind fastener from the receiver to a second (extended) position where the gripper delivers the blind fastener to the threaded screw tool for setting in the workpiece. The handover unit comprises a conveyance system for moving the gripper along a predefined pathway. The conveyance system includes a first support member spaced apart from a second support member. The support members have at least one track for guiding the movement of handover unit and correspondingly the gripper. In some embodiments this is done with guide bearings which limit the conveyance system's movement to a predefined pathway provided by the tracks. A piston actuator is operably engaged to the conveyance system and drives the extension and retraction of the conveyance system.

Yet another aspect of the present disclosure relates to a method for providing blind fasteners to a threaded screw tool of a setting tool. The method comprises taking one of the devices or assemblies described above and positioning the gripper is in the retracted position. The method further comprises delivering a blind fastener through the receiver and into the receptable of the gripper. Next, moving the clamping jaws from an open position to a closed position to secure and orient the blind fastener in the gripping assembly. Then, the handover unit is moved along the extendable conveyance system from an initial retracted position to an extended position. Movement of the handover unit correspondingly moves the gripper axially outward and radially inward until the gripper is positioned in front of the threaded screw tool wherein the blind fastener is aligned with the threaded screw tool axis. The screw tool rotates to thread the blind fastener onto the screw tool. The setting tool extends the screw tool outward linearly toward the opening in the workpiece to secure the blind fastener to the workpiece.

### BRIEF DESCRIPTION OF THE DRAWINGS

FIG. 1 is a perspective view of an embodiment of the setting device showing the gripper in a retracted position and the handover unit on the right side of the setting tool.

FIG. 2 is a perspective view of an embodiment of the setting device showing the gripper in a retracted position and the handover unit on the right side of the setting tool.

FIG. 3A is a perspective view of an embodiment of the setting device showing the gripper in a retracted position and the handover unit on the left side of the setting tool.

FIG. 3B is a perspective view of an embodiment of the setting device showing the gripper in a partially extended position and the handover unit on the left side of the setting tool.

FIG. 3C is a perspective view of an embodiment of the showing the gripper in an extended position and the handover unit on the left side of the setting tool.

FIG. 4 is a perspective view of the setting device mounted to a stationary mounting system and attached to an external blind fastener feeding system.

FIG. 5A is a sectional view of the setting tool showing the tool screw and the tool shaft in a retracted position.

FIG. 5B is a sectional view of the setting tool showing the tool screw in an extended position and inserted into a blind fastener held by the gripper.

FIG. 5C is a sectional view of the setting tool showing the tool screw being directed to an opening of a workpiece.

FIG. 6 is an exploded view of the receiver.

FIG. 7 is a perspective view of a portion of the receiver and the gripper.

FIG. 8 is a section view taken at line VIII in FIG. 7 showing a portion of the receiver and the gripper.

FIG. 9 is a perspective view of the handover unit and the gripper.

FIG. 10 is a section view of the handover unit and the gripper.

FIG. 11 is an exploded view of the handover unit.

FIG. 12 is a side view of a linkage bar assembly.

FIG. 13A is a side view of an alternative linkage bar assembly in a retracted position.

FIG. 13B is a side view of an alternative linkage bar assembly in an extended position.

FIG. 14 is an exploded view of the gripper.

FIG. 15 is a perspective view of the clamping mechanism engaging a blind fastener.

FIG. 16A is a front view of an embodiment showing teeth projecting inward from the clamping jaws and the clamping jaws in a first position.

FIG. 16B is front view of the embodiment showing teeth projecting inward from the clamping jaws and the clamping jaws in a second position.

### DETAILED DESCRIPTION

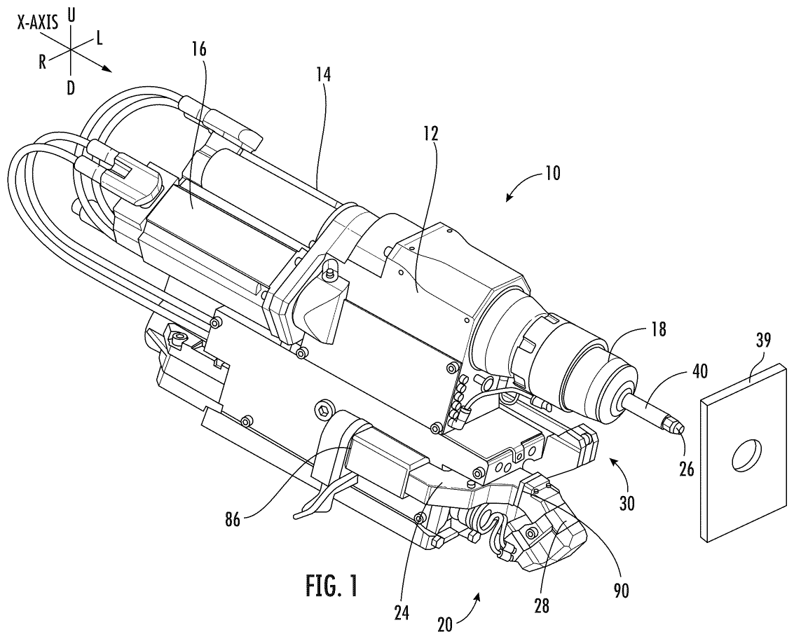

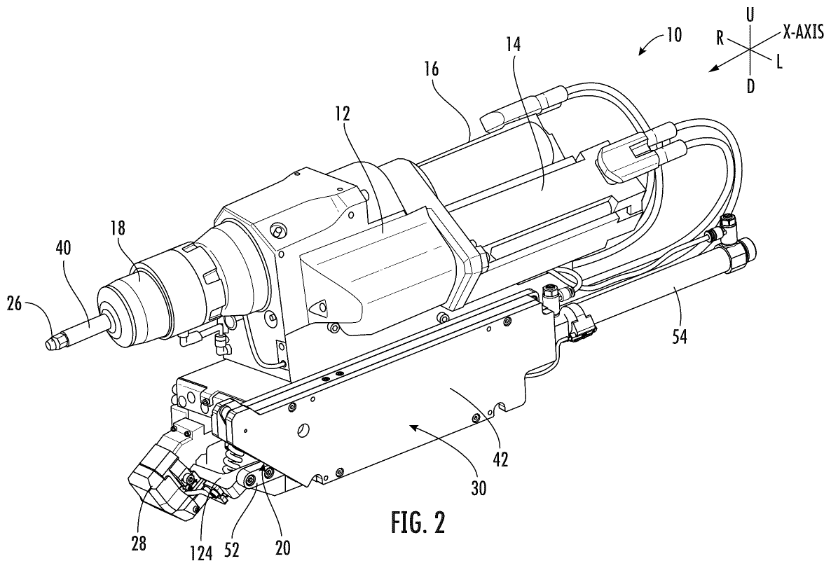

For purposes of description herein, the terms “up,” “down,” “right,” “left,” and derivatives thereof shall relate to the directional key shown in FIGS. 1 and 2 with reference to the setting tool 10. The terms “rear” and “front” are with respect to the tool axis X as shown in FIGS. 1 and 2. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

FIGS. 1-4 show a setting tool 10 for attaching blind fasteners 26 to a surface of a workpiece 39. The blind fastener 26 is shown and described herein as a blind rivet nut, but other types of blind fasteners may also be used. Typically, the assemblies, systems, and methods of the present disclosure are envisioned for use in motor vehicle manufacture, however, they may be used in other types of manufacturing as well. As shown, the setting device 10 has a housing 12 with a first motor 14 and second motor 16, a tool nose 18 proximate a front of the setting device 10, and a part presenter 20 for delivering blind fasteners 26 to the tool nose 18. The part presenter 20 generally includes a receiver 24 for delivering blind fasteners 26 to a gripper 28 and a handover unit 30 configured to move the gripper 28 from a first position for receiving blind fasteners 26 from the receiver 24 to second position axially outward and radially inward toward the tool axis X wherein the blind fastener 26 is delivered to the threaded screw tool 36 (within anvil sleeve 40 in FIGS. 1-4) at the tool nose 18.

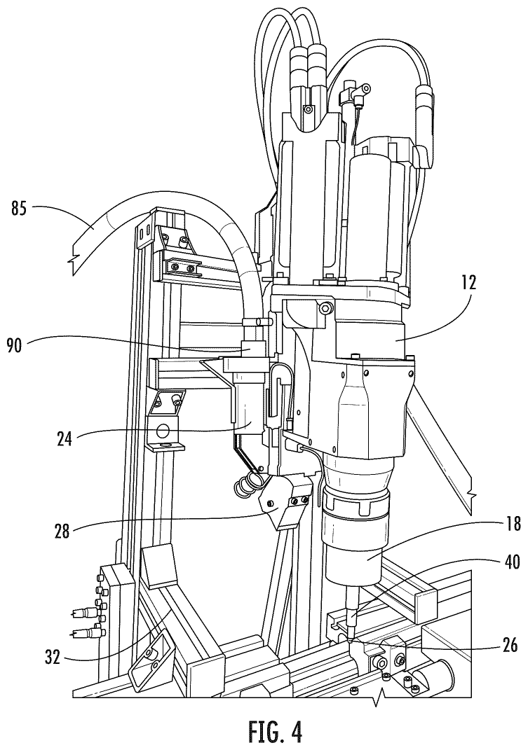

In some embodiments, the setting tool 10 of the present disclosure is integral with a robotic arm or similar mobile positioning device (not shown). The robotic arm may move the setting tool 10 into position such that the tool nose 18 is aligned with an opening or aperture in a thin wall or cover of a workpiece 39. In another embodiment shown in FIG. 4, the setting tool 10 is set on a stationary mount 32. In this case, only a tool screw 36 moves to engage the workpiece 39, and the rest of the setting tool 10 remains still relative to the stationary mount 32 or other mounting means. In yet another embodiment, the setting tool 10 is mounted on a rail or similar system wherein the setting tool 10 has limited movement to perform its fastening operation, such as up and down or back and forth linearly.

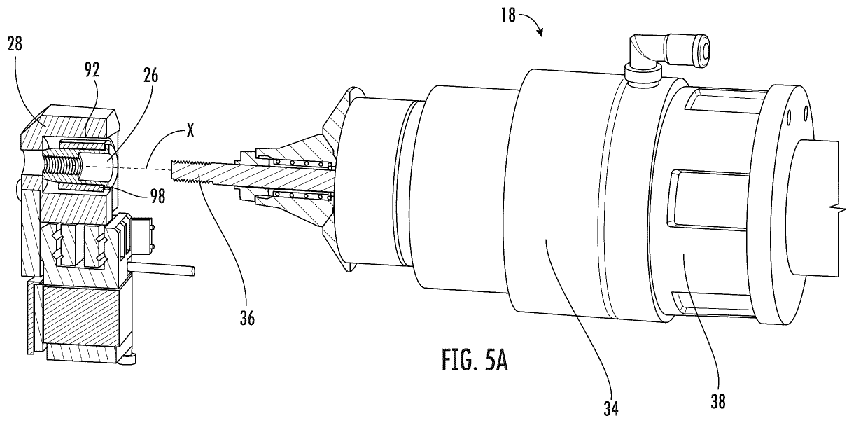

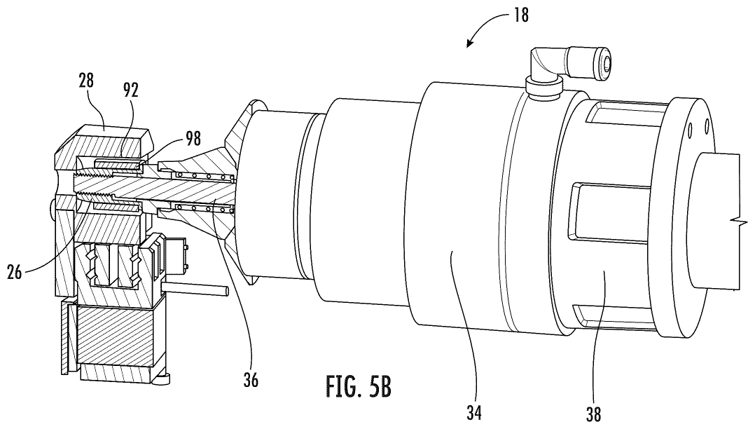

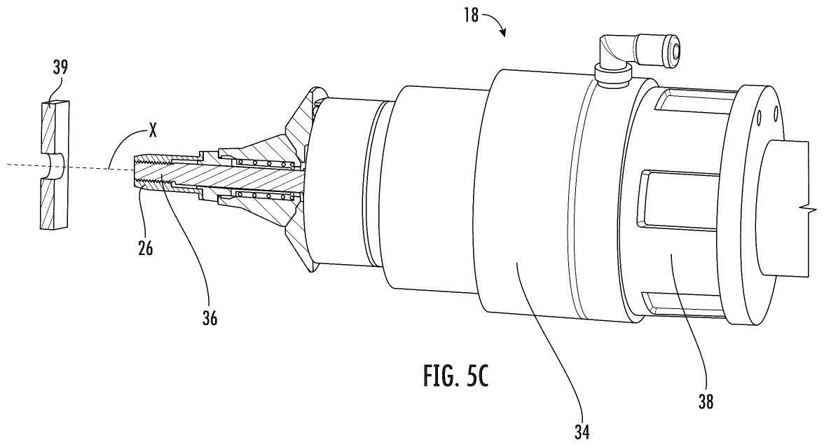

FIG. 5A shows the screw tool 36 extending from the tool housing 12 toward a blind fastener 26 held by the gripper 28. FIG. 5B shows the screw tool 36 engaging the internal thread of a blind fastener 26. The screw tool 36 is rotationally and translationally movable through a first and second transmission device which respectively work with a first and second electric motor 14, 16, as more fully described in U.S. Pat. No. 11,738,384 (Gianferrara et al.) issued Aug. 29, 2023. The tool screw 36 is rotationally and translationally movable along and around the longitudinal tool axis X.

As shown in FIGS. 5A and 5B, the tool nose 18 may further comprise an anvil sleeve 40 around the screw tool 36 and that extends outward from the screw tool 36. When attaching the blind fastener 26 to the screw tool 36, the tool nose 18 is moved forward towards gripper 28 (as further described below), with the screw tool 36 and the anvil sleeve 40 around it. After the blind fastener 26 has been attached, the roller screw is moved backwards. The screw tool 36 is thus moved relative to the tool sleeve 40. Once the anvil sleeve 40 contacts the head of the blind fastener 26, the blind fastener 26 cannot be retracted any further and it is fully prepared to be attached to a workpiece 39. The setting tool 10 is moved into position near an opening of a workpiece 39 and the blind fastener 26 and the screw tool 36 are inserted into the opening. Once the head of the blind fastener 26 contacts the surface of the workpiece 39 (possibly detected by a displacement transducer inside the tool) the crimping process starts. The screw tool 36 moves backwards inside the setting tool 10 to a specific force and distance. Thereby the screw tool 36 moves relative to the anvil sleeve 40, which remains stationary. The screw tool 36 crimps the blind fastener 26 and forms a bulge on the backside of the opening. The roller screw unscrews the screw tool 36 and pulls back until another blind fastener 26 is provided.

The setting tool 10 further comprises a control unit. The control unit is in signal communication with the first motor 14 and the second motor 16, and is able to run each independently in order to provide the necessary movement of the screw tool 36 to connect with the blind fastener 26. The control unit is also in signal communication with sensors (proximity sensor 94, sensor module 99) on the receiver 24 and the gripper 28, as more fully described below.

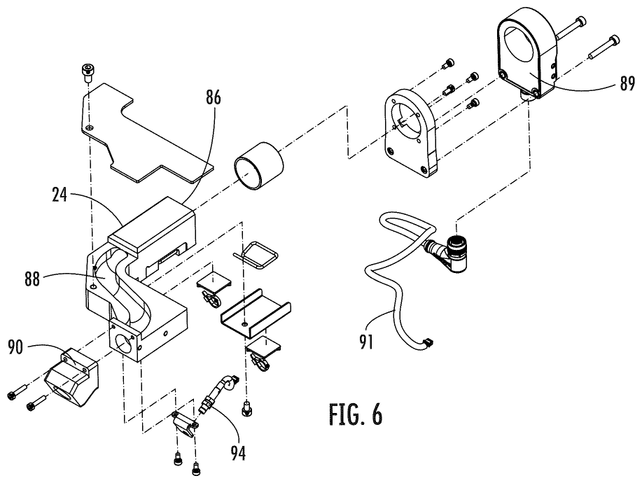

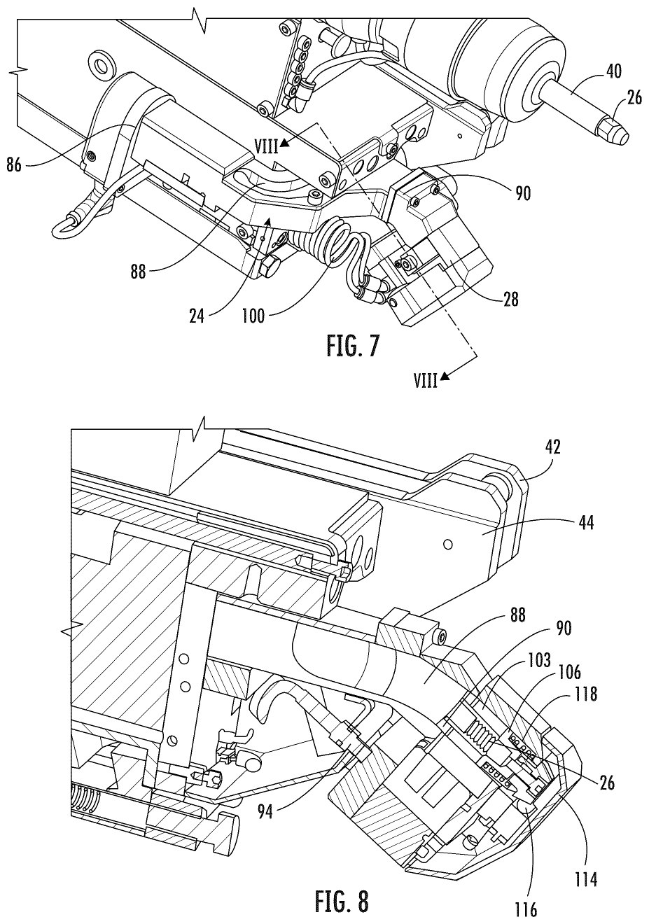

The part presenter 20 moves the blind fastener 26 along a predefined path from the supply area or magazine (not shown) to the screw tool 36 before the setting operation described above. The part presenter 20 generally includes a receiver 24, a gripper 28, and a handover unit 30. As shown in FIGS. 6-8, the receiver 24 is configured to direct a blind fastener 26 from the supply area to the gripper 28. The receiver 24 generally comprises a fastener supply tube 85 in communication with the blind fastener supply area, which may not be part of the setting tool 10 (FIG. 4). The receiver 24 further comprises a channel 88 having an input end 86 and an output end 90. The fastener supply tube 85 is engaged to the input end 86 of the feeder 88. Blind fasteners 26 are typically supplied through the receiver 24 one at a time. In some embodiments the channel 88 has dimensions such that a single blind fastener 26 may travel along the length of the receiver 24 while not being able to flip around or otherwise reposition itself. In this embodiment the internal diameter of the channel 88 is less than the length of the blind fastener 26.

The receiver 24 is operatively combined with the setting tool 10. In some embodiments a portion of the receiver 24 may extend along the outside of the setting tool 10 in order to deliver the blind fastener 26 to the gripper 28. The output end 90 of the receiver 24 is located adjacent to the gripper 28 when the gripper 28 is in the retracted position. The gripper 28 includes a receptacle 92 configured to receive a blind fastener 26 from the receiver 24. The receiver 92 is substantially aligned with the output end 90 of the channel 88 such that the blind fastener 26 moves into the receptacle 92 without catching on the gripper 28 or any other component of the handover unit 30. In some embodiments individual blind fasteners 26 are propelled through the receiver 24 utilizing compressed air. The source of the compressed air may be the same as the compressed air provided to the actuator 54 of the handover unit 30. Other propulsion means may also be used, including springs and gravity.

The output end 90 of the receiver 24 may be equipped with a proximity sensor 94 as shown in FIG. 6. The proximity sensor 94 determines whether the gripper 28 is in the retracted position and ready to receive a blind fastener 26. The proximity sensor 94 may be a magnetic, a capacitive, an inductive, an ultrasonic, or a photoelectric proximity sensor, or any other proximity sensor known in the art. If the handover unit 30 is not detected by the sensor 94, then the control unit prevents the receiver 24 from providing a blind fastener 26.

The receiver 24 may be provided with a stop function to prevent delivery of a blind fastener 26 if certain conditions are detected. A gate 89 or a lever is arranged in the receiver 24 and is adapted to prevent delivery of a blind fastener 26 and/or slow down the blind fastener 26 before it travels through the channel 88. The gate 89 or lever may be arranged proximate to the input end 86 of the receiver 24. The gate 89 or lever stops the blind fastener 26 until a signal is sent to the control unit confirming the gripper 28 is in its retracted position or that a setting step is needed, and no other blind fasteners 26 are present in the receiver 24 or gripper 28. This ensures that the blind fasteners 26 are supplied only one at a time. The gate 89 may be powered pneumatically by a gate delivering compressed air line 91.

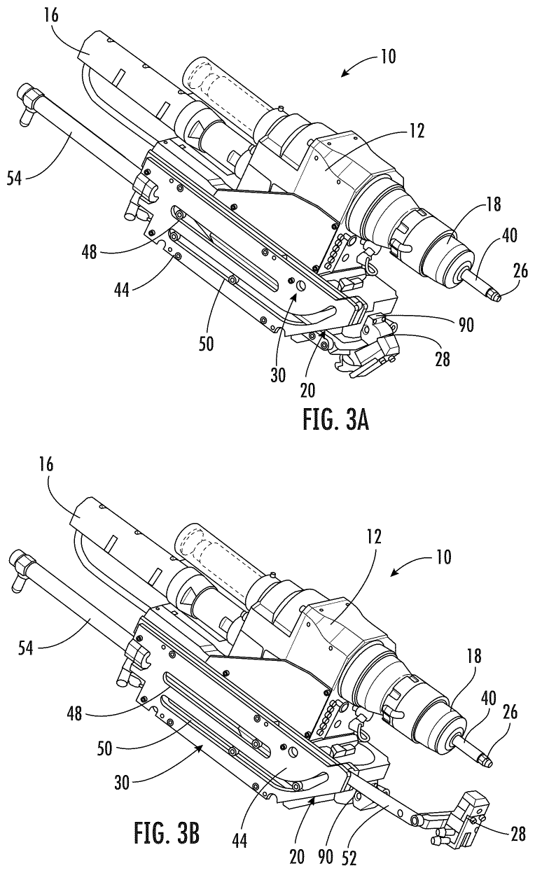

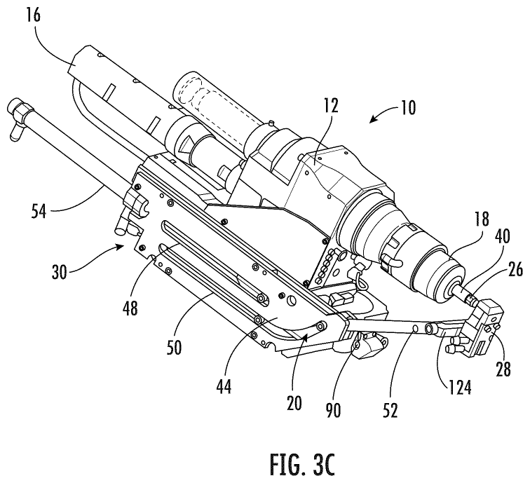

The part presenter 20 comprises a gripper 28 configured to receive, hold, and orient the blind fastener 26, and a handover unit 30 configured to move the gripper 28 along a predefined path between a first, retracted position and a second, extended position. FIG. 3A shows the retracted position wherein the gripper 28 is proximate to the receiver 24 for receiving blind fasteners 26 into the receptacle 92. FIG. 3B shows the gripper 28 in an intermediate position.

FIG. 3C shows the gripper 28 in the extended position in front of the tool nose 18 of the setting device 10. During extension, the gripper 28 is moved axially outward and radially inward toward the tool axis X. No lateral (left/right) movement is necessary because the receiver 24 is aligned with the screw tool 36 when the gripper receives the blind fastener 26 in its retracted position. Thus, the gripper 28 only moves in two dimensions between its retracted and extended positions. As explained in more detail below, in one embodiment the extension and retraction path of the gripper 28 is that of an arc or smooth curve. The extension path includes axial movement outward away from the housing of the setting tool 10 and radial movement inward toward the tool axis X, but the path does not include any rotation or axial retraction during extension. In other words, the gripper 28 is extended farthest from the setting tool 10 axially in its second position, the gripper 28 does not extend out then retract axially back toward the tool nose 18. This minimal movement helps reduce the clearance area around the setting tool 10 required for operation. Similarly, during the extension path of the gripper 28, the gripper 28 is extended farthest radially in its second position.

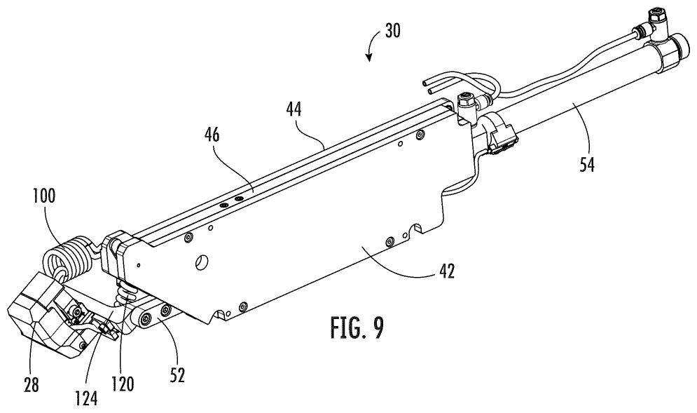

The handover unit 30 shown in FIGS. 9-13B comprises a mechanical assembly for guiding the gripper 28 along the predefined path between the first position proximate to the receiver 24 and the second position proximate to the tool nose 18. The gripper 28 is coupled with handover unit 30 such that when the handover unit 30 is moved by the actuator 54 the gripper 28 is also correspondingly moved. The handover unit 30 includes a first support member 42 and a second support member 44, with both support members being spaced apart at a predetermined distance by one or more spacers 46. The support members 42, 44 may be support plates or brackets. In some embodiments the support members 42, 44 each have one or more tracks that are cut into or supported by the interior facing surfaces of each support member 42, 44.

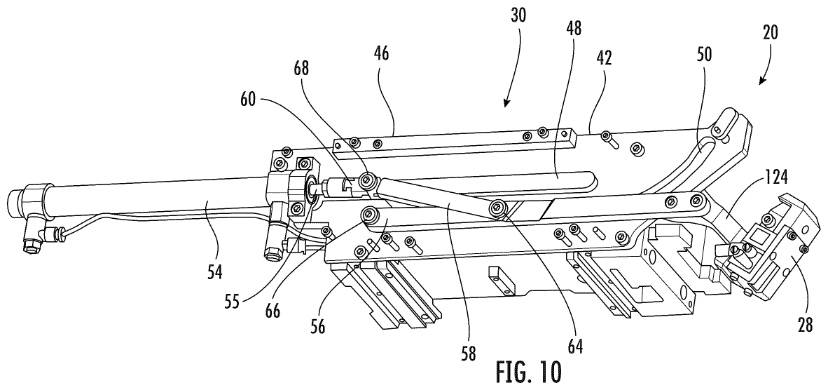

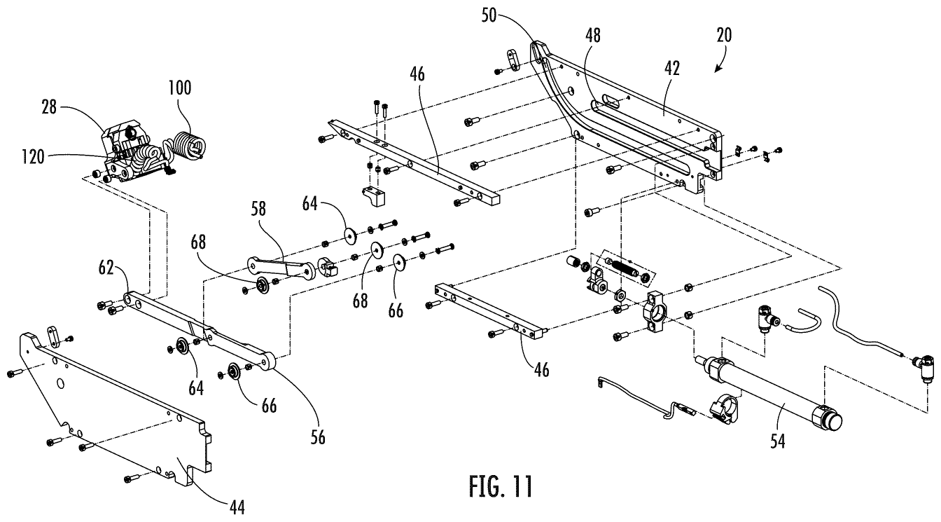

FIGS. 10-11 show an embodiment wherein the handover unit 30 has two tracks (a first track 48 and a second track 50) in each support member 42, 44. In some embodiments the tracks 48, 50 are elongated openings extending through the support members 42, 44 from the interior surface to the exterior surface. In some embodiments the tracks 48, 50 on each support member 42, 44 mirror the tracks 48, 50 on the other. As shown in FIG. 10, the first track 48 is generally a linear or straight track extending generally parallel to the tool axis X and located above the second track 50. The first track 48 has a first portion near the rear of the support members 42, 44 and a second portion near the front of the support members 42, 44. The first track 48 has a length shorter than a length of the second track 50. The second track 50 includes a linear portion generally parallel to the first track 48, but also includes a curved portion curving radially upwards toward the tool axis X along its length toward the front of the setting tool 10. In some embodiments, the linear portion of the second track 50 is on one side of the first track 48 and the curved portion of the second track 50 terminates on another side of the first track 48 at a height that is above the first track 48. In these embodiments, the second track 50 begins below and parallel to the first track 48 then curves radially upward toward the tool axis X past the second portion of the first track 48 to end above the first track 48. This configuration helps allow the gripper 28 to move axially outward away from the tool housing and also radially upward toward the tool nose 18.

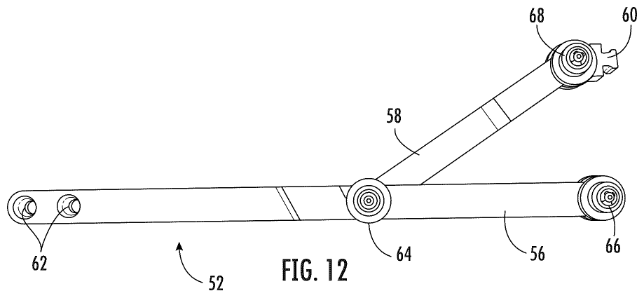

A linkage bar assembly 52 is held between the support members 42, 44 and is engaged to an actuator 54. The actuator 54 may be a pneumatic or hydraulic cylinder with an extendable piston 55. One embodiment of the linkage bar assembly 52, as shown in FIG. 12, includes a first bar 56, a second bar 58 axially engaged to the first bar 56 by a first end of the second bar 58, and an actuator attachment portion 60 attached axially to the second end of the second bar 58. The first bar 56 has a first opening located proximate the middle of its length, and a second opening near its rear end. There is at least one opening 62 or similar engagement means at the front end of the first bar 56. A gripper attachment member 124 connects the gripper 28 to the handover unit 30. In one embodiment the gripper attachment member 124 is a generally L-shaped member with an angled portion configured to overcome the radial inward movement of the gripper 28 to present the gripper 28 both planar and perpendicular to the tool axis X. to the first bar 56 via the at least one opening 62. The second bar 58 has a first opening at its first end that is aligned with the first opening on the first bar 56. The second bar 58 has a second opening at its second end. There is a first pair of guide bearings 64 engaged to the first openings of the first bar 56 and the first openings of second bars 58 on either side via a pin. A second pair of guide bearings 66 is engaged to the second opening of the first bar 56, and a third pair of guide bearings 68 is attached to the second opening of the second bar 58. Both the second and third pair of guide bearings 66, 68 are engaged to their respective openings with pins or similar fastening component. The first and second pair of guide bearings 64, 66 are disposed within the second tracks 50, and the third pair of guide bearings 68 are disposed within the first tracks 48. Each guide bearing in a pair of guide bearings is axially engaged to one another, and is on an opposite side of their respective area of the linkage bar assembly 52.

When a force is applied to the attachment portion 60 of the linkage bar assembly 52, it is pushed along the path of the first tracks 48 towards the front end of the setting device 10. The force is applied by the actuator 54 shown in FIGS. 9-11. This, in turn, pushes against the second end of the second bar 58 and forces it along the same path. The first end of the second bar 58 and the first bar 56 are then pushed along the path defined by the second tracks 50. The curved portion of the second tracks 50 causes the guide bearings to be directed upwards to follow the curve, providing the radial inward movement for the gripper 28. The first pair of guide bearings 64 along the middle of the first bar 56 reaches the curved portion before the second pair of guide bearings 66 at the rear of the first bar 56, so the first pair of guide bearings 64 is raised above the second pair of guide bearings 66. The first bar 56 is brought from a horizontal position to a forwardly extended angled position. The gripper 28, which is fixedly engaged to the first bar 56 at its front end, is also moved upwards and forwards following the path of the front end of the first bar 56. The movement of the linkage bar assembly 52 stops when either the third pair of guide bearings 68 reach the front end of the path of the first tracks 48 or when the first pair of guide bearings 64 of the first bar 56 reaches the front curved ends of the second tracks 50. The front end of the first bar 56 thus has a path that moves in two dimensions, such as axially outward away from the housing 12 and radially upward toward the tool nose 18. The outward movement is generally in the direction of the axis of the screw tool 36. The upward motion is generally radially inward toward the axis X of the screw tool 36. Together, the two dimensions of the movement form a generally curved path. The gripper 28, which is fixedly engaged to the front end of the linkage bar assembly 52, follows the same path so it is moved upward and outward to its second position in front of the tool nose 18 as previously described.

The handover unit 30 may be positioned on either side of the setting tool 10 depending on the needs of the manufacturer. FIGS. 1 and 2 show the handover unit 30 on one side while FIGS. 3A-3C show the handover unit 30 on another side of the setting tool 10. In any case, the gripper 28 should be operably attached to the handover unit 30 such that it is aligned with the output end 90 of the receiver 24.

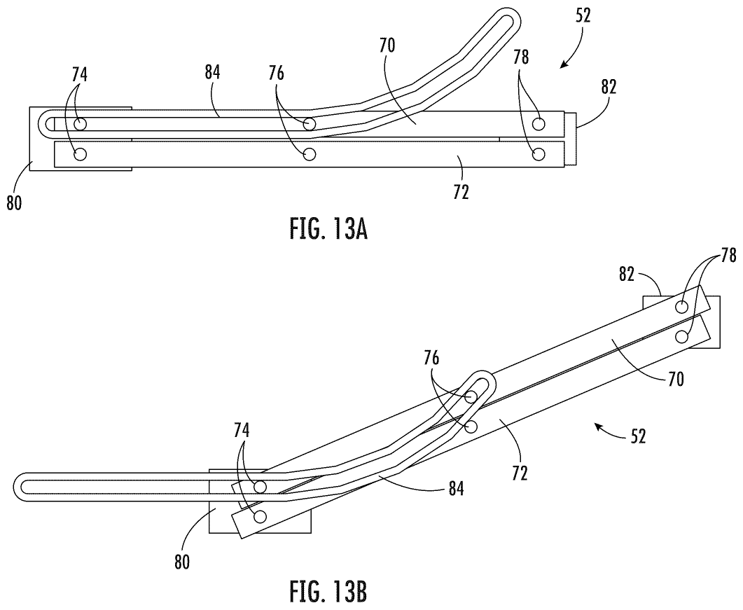

In another embodiment of the handover unit 30 shown in FIGS. 13A and 13B, the first bar 56 and the second bar 58 of the linkage bar assembly 52 are exchanged with one or more bars 70, 72. Some embodiments comprise a first, upper bar 70 and a second, lower bar 72. Both the upper 70 and lower bars 72 are generally parallel with one another and substantially the same shape and length. Both bars 70, 72 further include a rear pair of bearings 74 near the rear end of the bar, a middle pair of bearings 76 near a midpoint of the bar, and a front pair of bearings 78 near the front end of the bar. The rear pair of bearings 74 of the upper 70 and lower bars 72 are rotatably engaged to a piston engagement member 80. The front pair of bearings 78 of both the upper 70 and lower 72 bars are rotatably engaged to a gripper engaging member 82. A curved track 84 is disposed on both of the support members 42, 44. A second track 50 is not required.

The track 84 includes a straight portion generally parallel with the tool axis X and a curved portion. At least some of the bearings on the upper 70 or lower 72 bar are positioned in the track 84 so the bars 70, 72 move along the track 84. In some embodiments the rear pair of bearings 74 and the middle pair of bearings 76 of the upper bar 70 are positioned within the curved track 84. When the piston 55 is actuated, it pushes on the piston engagement member 80, thereby pushing on the upper 70 and lower bars 72 relative to the curved track 84. The movement of the pairs of bearings of the upper bar 70 along the path of the single curved track 84 is similar to the movement with respect to FIGS. 11 and 12.

FIG. 13A shows the resting position of the upper 70 and lower bars 72, before the actuator 54 applies a translational force on them. The piston engagement member 80 and the gripper engaging member 82 are held in an upright position, with the front bearing 78 and rear bearing 74 held in alignment one over the other. When the actuator 54 extends and pushes the upper and lower bars forward, the middle pair of bearings 76 of the upper bar 70 will reach the curved portion of the single curved track 84 before any other pair of bearings. As shown in FIG. 13B, the middle pair of bearings 76 will be moved upwards as well as forwards, and above the rear pair of bearings 74 of the upper bar 70. Thus, the upper bar 70 is directed into an angled position with the front end and front pair of bearings 78 being higher than the rear end and rear pair of bearings 74. The indirect connection with the upper bar 70 via the piston engagement member 80 and the gripper engaging member 82 causes the lower bar 72 to be oriented at an angle as well. When the upper 70 and lower 72 bars have reached their final, extended position, they will still be parallel, and the piston engaging member 80 and the gripper engaging member 82 will still be oriented upright as they were before when the bars 70, 72 were in the initial retracted position. The gripper 28 is thereby substantially maintained at the same upright position, while being moved to its second position.

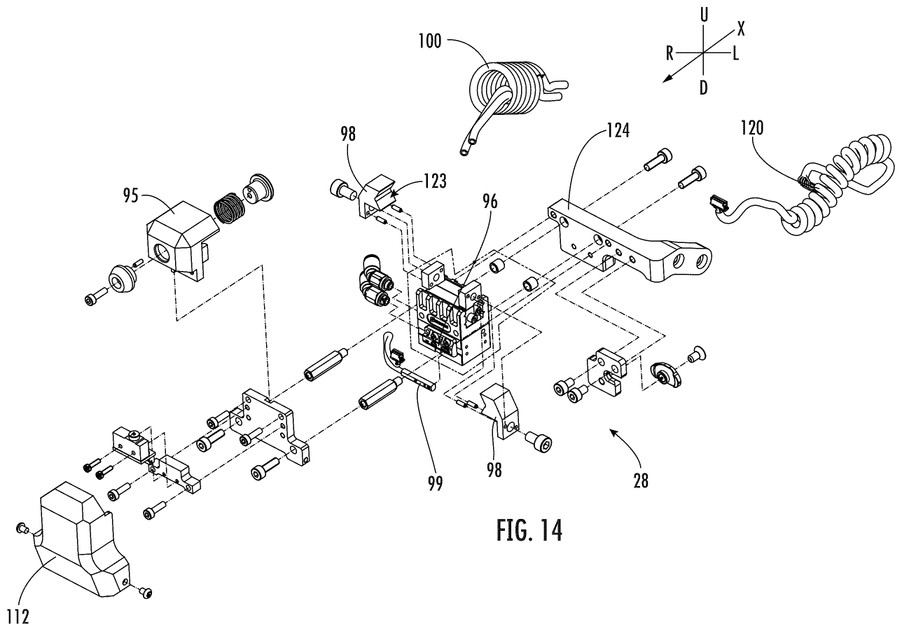

FIG. 14 shows the gripper 28 having an assembly housing 95 attached to the linkage bar assembly 52. Typically, the assembly housing 95 is fixedly engaged to the linkage bar assembly 52 and cannot move relative to the linkage bar assembly 52. The assembly housing 95 may be attached with fasteners, such as bolts or screws. The assembly housing 95 also provides a receptacle 92 configured to receive the blind fasteners 26 from the receiver 24. Access to the receptacle 92 is provided by an opening in the receiver 24 adjacent a side of the assembly housing 95. The gripper 28 also includes a clamping device 96, which has one or more clamping jaws 98. The inner profile of the jaws 98 may be contoured differently for different shapes of fastener 26 heads (e.g., round, hexagon, other polygon). The gripper 28 is configured to be combined with jaws 98 having different inner profiles depending on the shape of fastener 26 used for a particular setting operation. In some embodiments, the clamping jaws 98 are positioned on either side of the receptacle 92. The clamping jaws 98 are configured to move radially between an open position and a closed position to engage the outer surface of the blind fastener 26 and secure it in place within the receptacle 92. The clamping jaws 98 secure the blind fastener 26 such that it remains in the receptacle 92 during travel to the tool nose 18 regardless of the orientation of the gripper 28 relative to the ground. The clamping jaws 98 of the clamping device 96 can be designed to move automatically and can be operated hydraulically, pneumatically, electrically, or by any other suitable means. In some embodiments, the clamping jaws 98 are driven pneumatically with compressed air delivered to the clamping device 96 by a flexible compressed air line 100. The compressed air may be provided from a source on board the setting tool 10 or in an external location. This enables the gripper 28 to receive air from the setting tool 10 even if the linkage bar assembly 52 is in an extended position and the gripper 28 is further away from the setting tool 10.

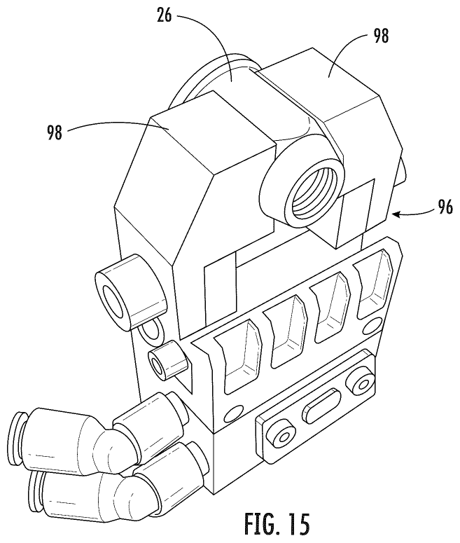

The clamping device 96 is shown in FIG. 15. The clamping device 96 may include a sensor module 99 having one or more sensors (shown in FIG. 14). In some embodiments, the sensors of the sensor module 99 are magnetic proximity sensors. In some embodiments two sensors are spaced apart within the sensor module 99 at two different locations. When the clamping jaws 98 are in an open position, they move a magnet to a first position near a first sensor within the sensor module 99. When the clamping jaws 98 are closed, they move the magnet to a second position near the second sensor within the sensor module 99. The sensors communicate with the control unit providing instructions for the setting tool 10 to rotate the screw tool 36 into the threads of the blind fastener 26, as well as to retract the blind fastener 26 when the clamping jaws 98 are released. The clamping device 96 can be easily reconfigured to accommodate fasteners of different sizes. A user or manufacturer repositions the magnet therein so that the clamping device 96 has a different “closed” distance. Only the clamping device 96 needs to be modified, and the rest of the setting tool 10 does not need to be adjusted in any way. In some embodiments of the present disclosure, the setting tool 10 may include a system for detecting a cross threading event between the blind fastener 26 and the screw tool 36. The gripper 28 may include a sensor or similar mechanism for sensing the blind fastener as it is forced further into the gripper 28 as disclosed in European patent application number EP24199305.4, which is hereby incorporated by reference. If cross threading is detected, then the setting tool 10 can be retracted in a controlled manner in a subsequent step so that the blind fastener 26 can be removed. This can be done, for example, by moving the blind fastener 26 into its loading position by simply moving the screw tool 36 in a backwards direction and preferably without any further rotational movement. In the loading position, the clamping device 96 can tightly secure the blind fastener 26 radially and the external thread of the screw tool 36 can be moved out of the internal thread of the blind fastener 26 by an opposite rotational movement and backward movement of the screw tool 36. Alternatively, the blind fastener 26 can of course also be removed manually by an operator from the exposed portion of the screw tool 36.

Some blind fastener 26 have a head portion with a circular cross section (as opposed to hexagon or other polygon shape). Normally, when there is no cross threading, the clamping jaws 98 supply enough friction/force to prevent the blind fastener 26 from slipping as the screw tool 36 rotates relative to the blind fastener 26. However, blind fasteners 26 having heads with smooth circular exteriors make it more difficult for the clamping jaws 98 to hold secure, especially in the case of cross threading. In other words, the blind fastener 26 may spin with the screw tool 36 as the screw tool 36 rotates trying to remove itself from the cross threaded blind fastener 26 because the jaws 98 cannot grasp the blind fastener 26 tight enough.

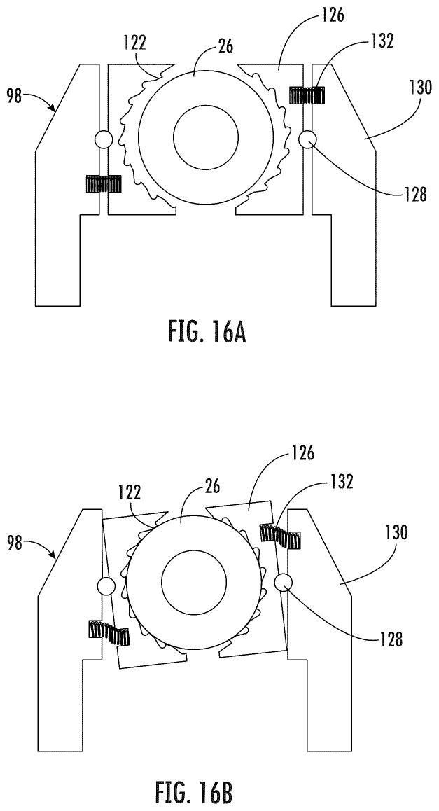

In the embodiments shown in FIGS. 16A-16B, the clamping jaws 98 comprise a base member 130 and a fastener engaging portion 126. The base member 130 is configured to be attached to a portion of the gripper 28. The fastener engaging portion 126 has teeth 122 extending radially inwardly from an inside surface to engage with a blind fastener 26. The fastener engaging portion 126 is pivotably attached to the base member 130 by a pivot member 128 such as a pin or hinge. A bias member 132 such as a spring is positioned between the fastener engaging portion 126 and the base member 130 to bias the two components 130, 126 a predetermined distance apart from each other and let the two components 130, 126 move relative to each other.

The teeth 122 are configured to engage and grasp the head of a blind fastener 26 by increasing friction between the two components 26, 98. In some embodiments, the teeth 122 are radially asymmetric such each tooth 122 has a moderate slope on one edge and a much steeper slope on the other edge. The asymmetry of each tooth 122 creates a pointed portion angled toward a first direction, which may be in a clockwise direction along the clamping jaws 98 when viewed from the front of the setting tool 10. The angled point of the teeth 122 provides more friction when the blind fastener 26 rotates in one direction (toward the point) and less friction when the blind fastener 26 rotates in the other direction (with the point). As the screw tool 36 is rotating to thread into the blind fastener 26, there is less friction between the teeth 122 and the blind fastener 26 because the blind fastener 26 is rotating toward the longer smoother part of the teeth 122. When the rotation is reversed such that the screw tool 36 is rotating to remove itself from the blind fastener 26, there is more friction because the blind fastener 26 is rotating toward the angled points of the teeth 122. This helps the jaws 98 hold the fastener 26 in place as the screw tool 36 unthreads from the blind fastener 26, especially in cross thread situations.

With further reference to FIGS. 16A-16B, the fastener engaging portion 126 further helps hold the blind fastener 26 in place when the screw tool 36 is rotating to unthread itself from the blind fastener 26. The spring 132 allows the fastener engaging portion 126 to rotate with the blind fastener 26 relative to the base member 130 about a pivot axis defined by the pivot member 128. As the teeth 122 engage the blind fastener 26, the fastener engaging portion 126 pivots around the pivot axis to increase the bite force between the teeth 122 and the blind fastener 26.

In some embodiments the teeth 122 may extend radially inward and generally longitudinally along the inner surface of the fastener engaging portion 126 (parallel to the longitudinal axis of the blind fastener 26). In other embodiments, the teeth 122 are helically wrapped around the inner surface of the fastener engaging portion 126. In this embodiment, the angled points of the teeth form a curved, helical path winding around the inner surface of the fastener engaging portion 126.

In order to provide a blind fastener 26 and engage the blind fastener 26 to a surface, the setting tool 10 undergoes the following process. Before receiving a blind fastener 26, the handover unit 30 is in an initial, retracted position as shown in FIG. 3A. In the retracted position, the linkage bar assembly 52 is not yet extended and the gripper 28 is positioned adjacent to the output end 90 of the receiver 24 with its receptacle 92 coaxially aligned with the channel 88 of the receiver 24. A single blind fastener 26 is delivered to the receiver 24 of the setting tool 10 via compressed air. The blind fastener 26, which may be a blind rivet nut, is injected into the receiver 24 at the input end 86, passes through the receiver 24, and is ejected from the output end 90 of the receiver 24 and into the receptacle 92 of the gripper 28. The clamping jaws 98 are moved from an open position to a closed position and they secure the blind fastener 26 in the receiver 24. If the blind fastener 26 has a hexagonal cross section (or other polygonal shape), then the shape of the inside surface of the jaws 123 will need to conform to the cross sectional shape of the blind fastener 26 intended to be used. In the case of a polygonal cross section, the straight sides of the clamping jaws 98 engage with the straight sides of the head of the blind fastener 26 to orient and rotate the blind fastener 26 until it reaches the correct predetermined orientation. Once the clamping jaws 98 are fully closed as determined by the proximity sensor 99, a signal is sent to the control unit indicating that the gripper 28 is ready to be moved by the handover unit 30. The piston 55 of the actuator 54 is extended, pushing the linkage bar assembly 52 of the handover unit 30 from a retracted position into the extended position. FIG. 3B shows the handover unit 30 while it is partially through its movement. The handover unit 30 completes its movement with the gripper 28 positioned in front of the screw tool 36 with the opening and threaded bore of the blind fastener 26 aligned with the screw tool 36 as in FIG. 3C. The control unit activates the motors to drive the screw tool 36 forward while rotating. The screw tool 36 is moved into the opening and into the threaded bore of the blind fastener 26.

After the blind fastener 26 has been threadedly engaged with the screw tool 36, the clamping jaws 98 are released from the blind fastener 26. The piston 55 is pulled back into the cylindrical actuator 54 and the handover unit 30 is pulled from the extended position back into the retracted position. The gripper 28 is brought back into engagement with the output end 90 of the receiver 24 and is ready to receive another blind fastener 26. The entire setting tool 10 is moved into position, whether it is on a rail system, robotic arm, or other movement system, so that the screw tool 36 and the attached blind fastener 26 are directed towards and generally aligned with an opening or opening on a workpiece 39. The screw tool 36 is extended forward until the blind fastener 26 passes into the opening and the head or flange of the blind fastener 26 contacts the exterior of the workpiece 39. The screw tool 36 is moved backwards into the setting tool 10, but the tool nose 18, and thus, the anvil sleeve 40 around the screw tool 36 stay still. The threaded region of the blind fastener 26 is moved backwards with the screw tool 36, but the blind fastener 26 will be unable to pass the anvil sleeve 40. A crimping of the blind fastener 26 occurs. A bead or a bulge is formed in the blind fastener 26 on the blind side of the workpiece 39 opposite to the setting tool 10. The blind fastener 26 is thus held captively in the opening. To remove the setting device 10 from the newly set blind fastener 26, the screw tool 36 is rotated in the opposite direction of the screw-on direction. The procedure is repeated any number of times depending on the number of openings on the workpiece 39 needing blind fasteners 26.

Having thus described the invention in connection with the preferred embodiments thereof, it will be evident to those skilled in the art that various revisions can be made to the preferred embodiments described herein without departing from the spirit and scope of the invention. It is my intention, however, that all such revisions and modifications that are evident to those skilled in the art will be included with in the scope of the following claims.

What is claimed is as follows:

1. A setting tool for a blind fastener including a head and a shank, the setting tool comprising:
a tool housing;
a screw tool including a male thread that is rotationally and translationally movable within the tool housing along and around a tool axis between a retracted position and an extended position;
a blind fastener presenting assembly for presenting blind fasteners to the screw tool, said blind fastener presenting assembly comprising:
a receiver having an input end and an output end;
a gripper having a receptacle configured to receive blind fasteners from the receiver and a clamping device disposed proximate the receptacle for securing the blind fastener, wherein the clamping device comprises clamping jaws having an open position and a closed position;
a handover unit configured to move the gripper along a path between a first position wherein the gripper is proximate the output end of the receiver and a second position wherein the gripper is proximate the screw tool, wherein the handover unit further comprises a first guide member having a first track extending generally parallel to the tool axis between a first portion and a second portion, the first track spaced from a second track having a first portion generally parallel to the tool axis and a second portion curving radially from the first portion of the second track toward the tool axis;
a linkage bar having a first guide bearing engaged with the first track and a second guide bearing engaged with the second track, wherein the first guide bearing is configured to move between the first portion of the first track and the second portion of the first track, and wherein the second guide bearing is configured to move between the first portion of the second track and the second portion of the second track.

2. The setting tool of claim 1 wherein the first track has an upper side and a lower side, and the first portion of the second track is on the lower side of the first track and the second portion of the second track is on the upper side of the first track.

3. The setting tool of claim 1 wherein the handover unit further comprises a second guide member having a first track extending generally parallel to the tool axis between a first portion and a second portion, the first track of the second guide member spaced from a second track of the second guide member having a first portion generally parallel to the tool axis and a second portion curving radially from the first portion of the second guide member toward the tool axis.

4. The setting tool of claim 3 wherein the linkage bar has a third guide bearing engaged with the first track of the second guide member and a fourth guide bearing engaged with the second track of the second guide member.

5. The setting tool of claim 1 wherein the linkage bar is configured to move in a path defined by the first track and the second track.

6. The setting tool of claim 1, wherein the handover unit is configured to move the gripper along the path axially outward and radially inward toward the tool axis.

7. The setting tool of claim 1, wherein the handover unit is configured to move the gripper axially and radially but not laterally.

8. The setting tool of claim 1, wherein the path of the gripper is an arc-shaped path.

9. The setting tool of claim 1, wherein the clamping jaws further comprise a plurality of teeth.

10. The setting tool of claim 9, wherein each tooth of the plurality of teeth extends radially inward from an inner surface of the clamping jaws asymmetrically such that each tooth of the plurality of teeth has a point formed by a first slope on a first edge that is steeper than a second slope on a second edge.

11. The setting tool of claim 1, further comprising a proximity sensor proximate to the output end, the proximity sensor is configured to detect a presence of the gripper.

12. The setting tool of claim 1 wherein the clamping device comprises a first sensor and a second sensor, wherein the first sensor is configured to detect the closed position of and the second sensor is configured to detect the open position.

13. The blind fastener presenting assembly of claim 1, wherein the blind fastener is a blind rivet nut.

14. A setting tool for a blind fastener including a head and a shank, the setting tool comprising:
a tool housing;
screw tool including a male thread that is rotationally and translationally movable within the tool housing along and around a tool axis between a retracted position and an extended position;
a blind fastener presenting assembly for presenting blind fasteners to the screw tool, said blind fastener presenting assembly comprising:
a receiver having an input end and an output end;
a gripper having a receptacle configured to receive blind fasteners from the receiver and a clamping device disposed proximate the receptacle for securing the blind fastener, wherein the clamping device comprises clamping jaws having an open position and a closed position;
a handover unit configured to move the gripper along a path between a first position wherein the gripper is proximate the output end of the receiver and a second position wherein the gripper is proximate the screw tool;
wherein the handover unit further comprises a first guide member spaced from a second guide member, each guide member having a first track and a second track, each first track extending generally parallel to the tool axis between a first portion and a second portion, each second track having a first portion generally parallel to the tool axis and a second portion curving radially from the first portion of the second track toward the tool axis.

15. The setting tool of claim 14, wherein the handover unit is configured to move the gripper along the path axially outward and radially inward toward a tool axis.

16. The setting tool of claim 14, wherein the path of the gripper is an arc-shaped path.

17. The setting tool of claim 14, wherein the clamping jaws further comprise teeth extending radially inward from an inner surface of the clamping at an angle.

18. A setting tool for a blind fastener including a head and a shank, the setting tool comprising:
a tool housing;
a screw tool including a male thread that is rotationally and translationally movable within the tool housing along and around a tool axis between a retracted position and an extended position;
a blind fastener presenting assembly for presenting blind fasteners to the screw tool, said blind fastener presenting assembly comprising:
a receiver comprising an input end and an output end;
a gripper comprising a receptacle configured to receive blind fasteners from the receiver and a clamping device disposed proximate the receptacle for securing the blind fastener, wherein the clamping device comprises clamping jaws having an open position and a closed position, wherein the clamping jaws further comprise a plurality of teeth extending radially from an inner surface of the clamping jaws, each tooth of the plurality of teeth is asymmetric such that each tooth of the plurality of teeth has a point formed by a first slope on a first edge that is steeper than a second slope on a second edge;
a handover unit configured to move the gripper along a path between a first position wherein the gripper is proximate the output end and a second position
wherein the gripper is proximate the screw tool.

19. The blind fastener presenting assembly of claim 18, wherein the handover unit is configured to move the gripper along the path axially outward and radially inward toward a tool axis.

20. The blind fastener presenting assembly of claim 18, wherein the path of the gripper is an arc-shaped path.
